(19) United States
(12) Patent Application Publication
(10) Pub. No.: US 2011/0036604 A1
(43) Pub. Date: Feb. 17, 2011

(54) MULTI-FUNCTION POWER TOOL

(75) Inventors: Kirk Worsnop, Nanjing (CN); Keith Park, Nanjing (CN)

Correspondence Address: GREENBERG TRAURIG, LLP, 77 WEST WACKER DRIVE, SUITE 3100, CHICAGO, IL, 60601-1732, US

(73) Assignee: CHERVON LIMITED, Wanchai (HK)

(21) Appl. No.: 12/850,743

(22) Filed: Aug. 5, 2010

(30) Foreign Application Priority Data
Aug. 11, 2009 (CN) 200910183793.4

(51) Int. Cl. B25F 3/00

(52) U.S. Cl. 173/29; 279/144

(57) ABSTRACT

A power tool has a body portion, a head portion, and a motor located in the body portion. A connecting spindle arranged within the head portion is driven by the motor for rotation. A first replaceable spindle is releasably connectable to the connecting spindle. The first replaceable spindle has a first output portion adapted for mounting a working head. A second replaceable spindle is additionally provided which is also releasably connectable to the connecting spindle. Two different working heads are mounted on the first output portion and the second output portion, respectively, to thereby provide a multi-function power tool.

### RELATED APPLICATION INFORMATION

This application claims the benefit of CN 200910183793.4, filed on Aug. 11, 2009, the disclosure of which is incorporated herein by reference in its entirety.

### BACKGROUND

This disclosure generally relates to power tools and, more particularly, relates to a multi-function power tool.

There currently exists many types of power tools, such as electric drills, angle grinders, sanding machines, and the like. Generally, different types of power tools can achieve different functions, and one kind of power tool often has only a single function. For example, an electric drill is used for drilling, an angle grinder is used for coarsely grinding metal, wood and other objects, and a sanding machine is used for finely grinding the wood surface. Therefore, at some places with architectural decoration, a users usually prepares a number of different types of power tools to achieve different functions in operation.

### SUMMARY

The following describes a multi-function power tool having replaceable spindles by which the power tool can achieve different functions such as grinding, polishing, etc. More particularly, the described power tool includes a body portion, a head portion, and a motor located in the body portion. A connecting spindle is arranged within the head portion and driven by the motor for rotation and a first replaceable spindle can be releasably fixed to the connecting spindle. The first replaceable spindle has a first output portion adapted for mounting a working head.

The multi-function power tool further includes a retaining assembly used for fixing the first replaceable spindle to the connecting spindle and the first replaceable spindle further comprises an upper portion which is connectable to the retaining assembly.

The multi-function power tool may additionally comprise a second replaceable spindle which can be releasably fixed to the connecting spindle. The second replaceable spindle has an upper portion, which is the same as the upper portion of the first replaceable spindle, and a second output portion where two different working heads are mounted on the first output portion and the second output portion, respectively.

As will become apparent, the hereinafter described, multi-function power tool can be provided with many different working heads for completing various functions by replacing the first and second replaceable spindles mounted on the connecting spindle and optionally mated with different working heads. In addition, with the retaining assembly, the replaceable spindles can be mounted on or released from the power tool quickly, and the operation is convenient and fast, without any use of other tools.

### BRIEF DESCRIPTION OF THE DRAWINGS

The subject multi-function power tool will be further described with reference to the accompanying figures, in which:

FIG. 1 is a perspective view of a first exemplary embodiment of a multi-function power tool constructed according to the description that follows;

FIG. 2 is an exploded view showing some of the structures of the power tool shown in FIG. 1;

FIG. 3 is a top view of the power tool shown in FIG. 1;

FIG. 4 is a sectional view of the power tool along the line A-A shown in FIG. 3, wherein the replaceable spindle is located at a position such that the replaceable spindle is retained on the connecting spindle;

FIG. 5 is a sectional view of the power tool along the line A-A shown in FIG. 3, wherein the replaceable spindle is located at a position such that the replaceable spindle can be released from the connecting spindle;

FIG. 6A is a perspective view of a second exemplary embodiment of a multi-function power tool constructed according to the description that follows;

FIG. 6B is an exploded view showing some of the structures of the power tool shown in FIG. 6A;

FIG. 6C is a sectional view of the power tool shown in FIG. 6A in the longitudinal direction;

FIG. 7A is a perspective view of a third exemplary embodiment of a multi-function power tool constructed according to the description that follows;

FIG. 7B is an exploded view showing some of the structures of the power tool shown in FIG. 7A;

FIG. 7C is a sectional view of the power tool shown in FIG. 7A in the longitudinal direction;

FIG. 8A is a perspective view of a fourth exemplary embodiment of a multi-function power tool constructed according to the description that follows;

FIG. 8B is an exploded view showing some of the structures of the power tool shown in FIG. 8A; and

FIG. 8C is a sectional view of the power tool shown in FIG. 8A in the longitudinal direction.

### DETAILED DESCRIPTION

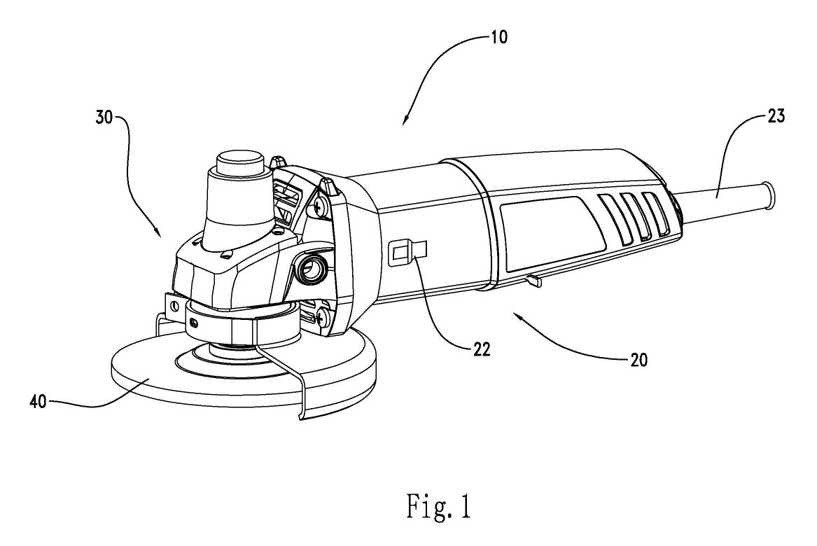

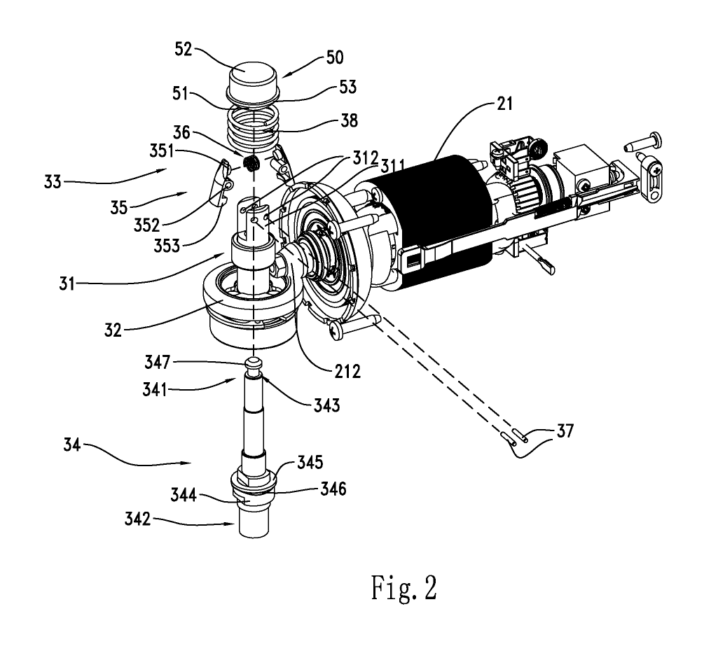

Now referring to FIG. 1 and FIG. 2, a multi-function power tool 10 constructed according to one of the preferred embodiments of the subject invention includes a body portion 20 and a head portion 30. A motor 21 is located in the body portion 20 and a switch 22, which can be operated by the user to control the starting and stopping of the motor 21, is installed outside of the body portion 20. In this embodiment, the power tool 10 includes an AC power line 23 extending from the body portion 20 to supply the motor with an external AC power. However, it is also possible to supply the motor by other means, such as DC power. A working head 40 is installed on the head portion 30. With an inner motion transmission mechanism, the motion of the motor 21 is transmitted to the working head 40 so as to drive the working head 40 to operate working objects associated with the working head 40. In this embodiment, the body portion 20 and the head portion 30 can be two separate components or a single component integrated with each other.

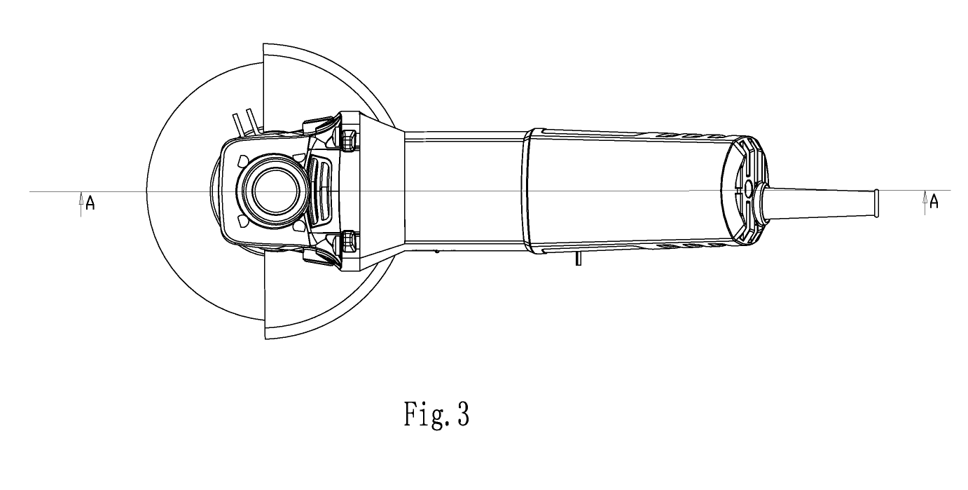

Referring to FIGS. 2-5, the motor 21 includes a motor output shaft 211 which has an axis 213 and a gear 212 is formed on one end of the motor output shaft 211 which is closest to the head portion 30. The head portion 30 includes a connecting spindle 31 which has a longitudinal axis 214, the longitudinal axis 214 is generally perpendicular to the axis 213 of the motor output shaft, and the connecting spindle 31 is hollow in the interior thereof. A bevel gear 32 is formed on the lower portion of the connecting spindle 31. The bevel gear 32 can be engaged with the gear 212 on the motor output shaft 211, so that the rotation of the motor output shaft 211, upon the motor 21 being turned on, will be transmitted to the bevel gear 32 via the mutually engaged gear transmission portions, and thereby the bevel gear 32 will drive the connecting spindle 31 to rotate. A retaining assembly 33 is arranged on the upper portion of the connecting spindle 31 for retaining an inner shaft 34 within the connecting spindle 31. When the inner shaft 34 is retained within the connecting spindle 31, the inner shaft 34 can rotate together with the connecting spindle 31, and can further drive the working head 40 to rotate since the working head 40 is arranged on the lower end of the inner shaft 34. Therefore, the motion of the motor can be transmitted to the working head 40 by the mutually engaged gear transmission portions, the connecting spindle 31, and the inner shaft 34 retained in the connecting spindle 31. The inner shaft 34 can be releasably retained within the connecting spindle 31, and the user can replace the inner shaft 34 as desired. The inner shaft 34 includes an upper connection portion 341 and a lower connection portion 342. The retaining assembly 33 will be described in detail below.

The retaining assembly 33 comprises a pair of clamping legs 35 arranged oppositely, and each of the clamping legs 35 includes a cylindrical protrusion 351 at the upper portion thereof, a through-hole 352 at the middle portion thereof, and a hook-shaped protrusion 353 at the lower portion thereof. A compression spring 36 is installed on the cylindrical protrusions 351 in a manner such that the spring 36 is connected to the cylindrical protrusion 351 of each clamping leg 35 at two ends thereof, respectively. The upper portion of the connecting spindle 31 has a pair of extended elements 311 which are arranged oppositely and provided with a cavity therebetween for receiving the retaining assembly 33. The pair of the extended elements 311 is also provided with holes 312 at the position corresponding to the through-holes 352. A pair of engaging pins 37 can extend through the holes 312 in the extended elements and the through-holes 352 in the clamping legs 35 so that the clamping legs 35 can be attached to the connecting spindle 31. A compression spring 38 surrounds the outside of the clamping legs 35 with the lower end thereof abutting against the end surface of a structural element 39 within the head portion and the upper end thereof connected to a lower protrusion 51 on an actuator 50. The actuator 50 also includes a cap-like portion 52 projecting to the outside of the head portion 30 to allow for touching by the user and a step portion 53 for restricting the actuator 50 within the head portion 30 so that the actuator 50 can not be completely disengaged from the head portion 30. The elastic force of the compression spring 38 drives the cap-like portion 52 to move outwardly toward the external of the head portion 30. The actuator 50 includes an interior cavity 54 for receiving the upper portions of the clamping legs 35, and a generally conical inner surface 55 is formed in the interior cavity 54.

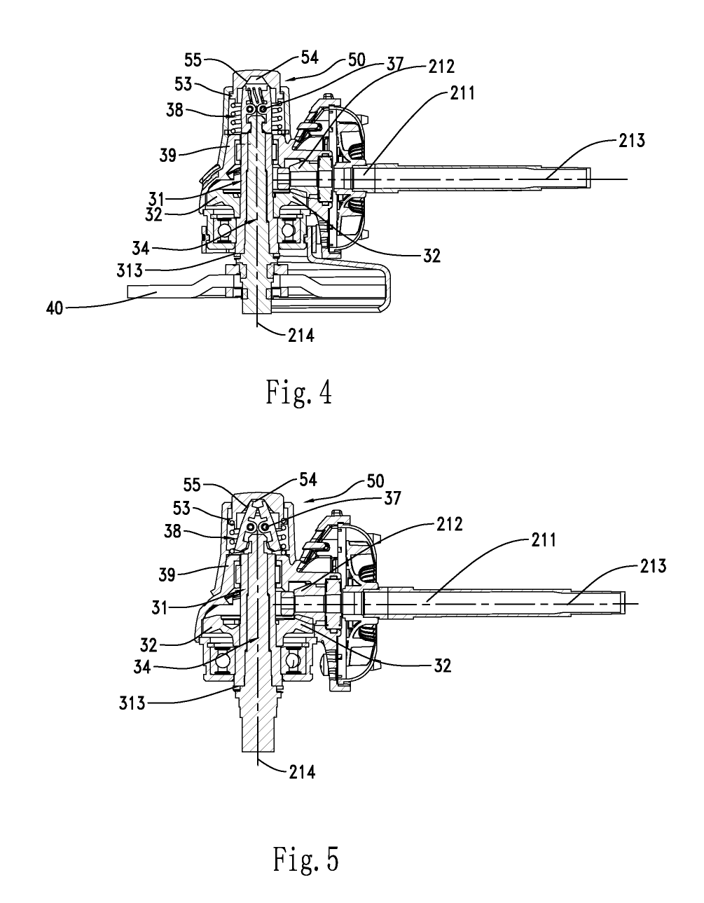

The elastic force of the compression spring 36 will drive the pair of clamping legs 35 to rotate inwardly around the engaging pins 37 after the inner shaft 34 is pushed upward into the clamping legs 35, so that the hook-shaped protrusions 353 of the clamping legs lock the upper connection portion 341 of the inner shaft which has a groove 343 for receiving the hook-shaped protrusions 353. A gasket 345 and a spring washer 346 are further arranged between the end surface of the step 344 of the inner shaft and the lower end surface 313 of the connecting spindle. The elastic force of the spring washer 346 may pull downwardly the inner shaft 34 so that the head 347 thereof abuts against the hook-shaped protrusions 353 of the clamping legs. With the mating of the hook-shaped protrusions 353 of the clamping legs and the groove 343, as well as the elastic effect of the spring washer, the inner shaft 34 can be fixedly retained in the connecting spindle 31, as shown in FIG. 4.

When the inner shaft 34 needs to be removed from the connecting spindle 31 as desired, the actuator 50 is firstly pressed to move downwardly by overcoming the elastic force of the spring 38, and the conical inner surface 55 of the actuator 50 also moves downwardly and acts on the upper end of the clamping legs 35 to make the clamping legs 35 rotate outwardly around the engaging pins 37 so that the hook-shaped protrusions 353 are separated from each other and disengaged from the groove 343 on the inner shaft, as shown in FIG. 5. In this way, the inner shaft 34 can be released from the retaining assembly 33 to be removed from the connecting spindle 31.

In the embodiment described above, only one kind of the retaining assembly is described, however, those skilled in this art will understand out that other retaining assemblies may be used to retain the inner shaft within the connecting spindle. The retaining assembly is also not limited to the described mechanical structure and may be other assemblies capable of performing the function of retaining the spindle, such as through the use of magnetic force and the like.

In the embodiment illustrated in FIG. 1, the working head 40 is a grinding wheel structure mated with the lower connection portion 342 of the inner shaft 34, so that the power tool 10 can be used as an angle grinder for angle grinding when the inner shaft 34 is retained in the connecting spindle 31. Therefore, the power tool 10 can achieve many different functions by replacing the inner shaft 34 with different output portions which can be mated with different working heads.

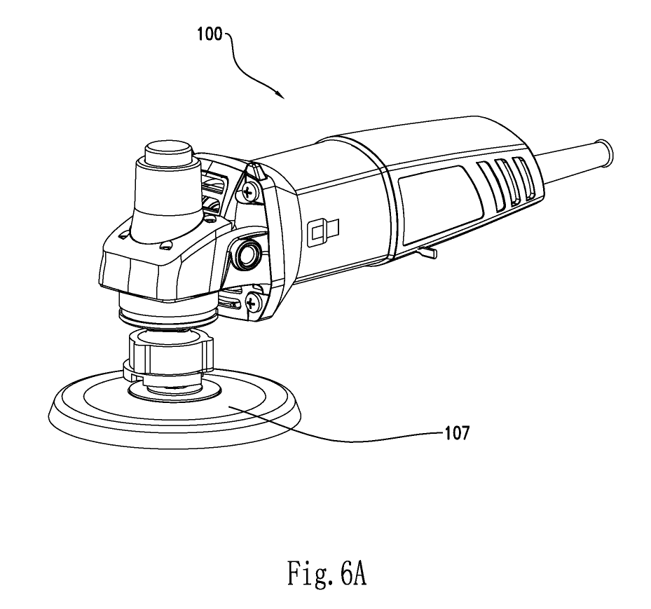

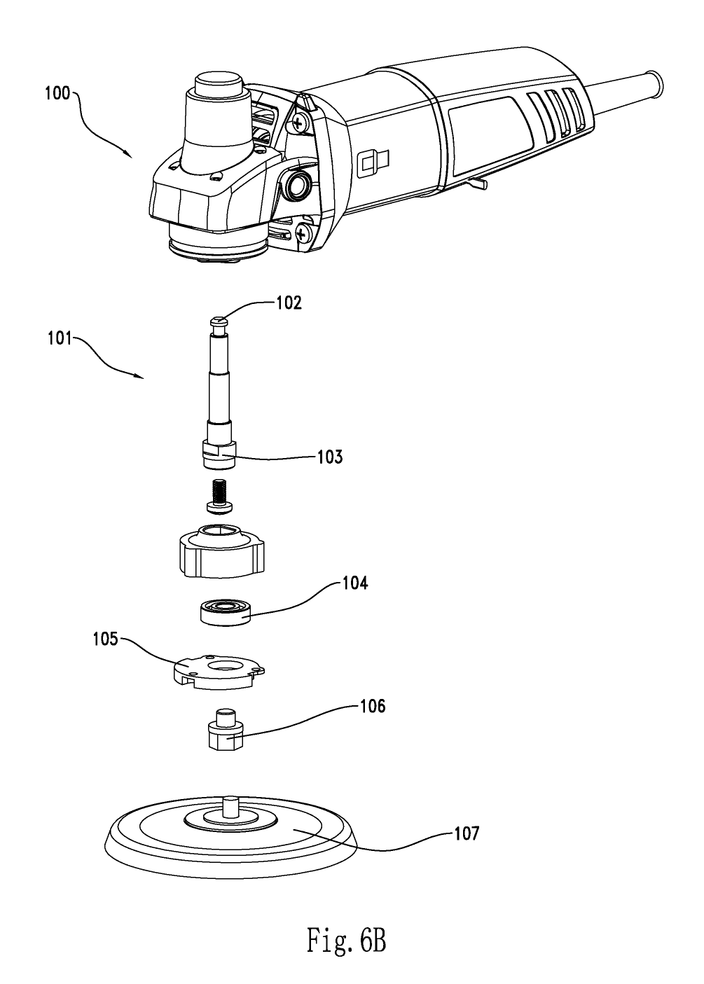

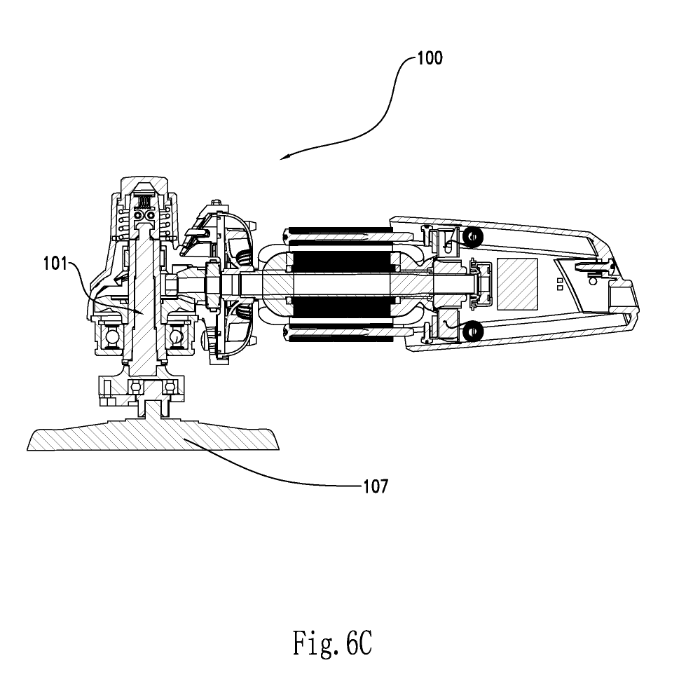

FIGS. 6A-6C illustrate another embodiment, wherein the power tool 100 is an orbital sander. The upper connection structure 102 of the inner shaft 101 may not be changed, but the lower connection structure 103 is eccentrically connected with a chassis 107 via a bearing 104, a balance block 105 and a locking nut 106, so as to achieve the function of the orbital sander.

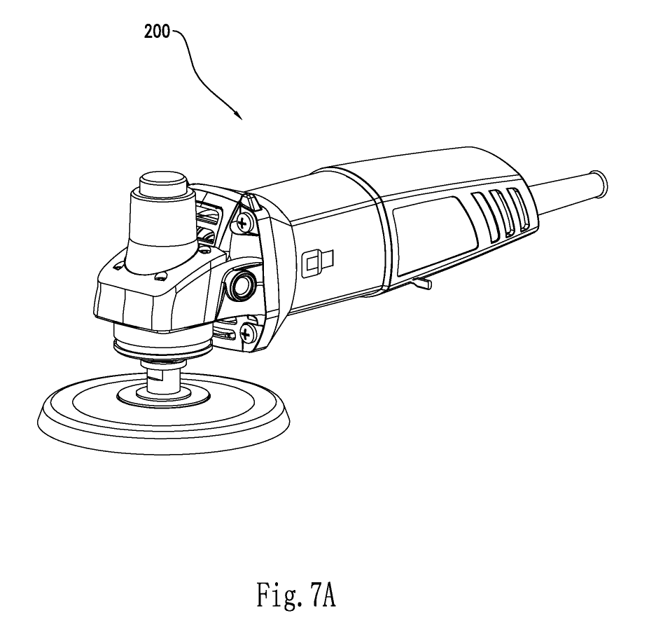

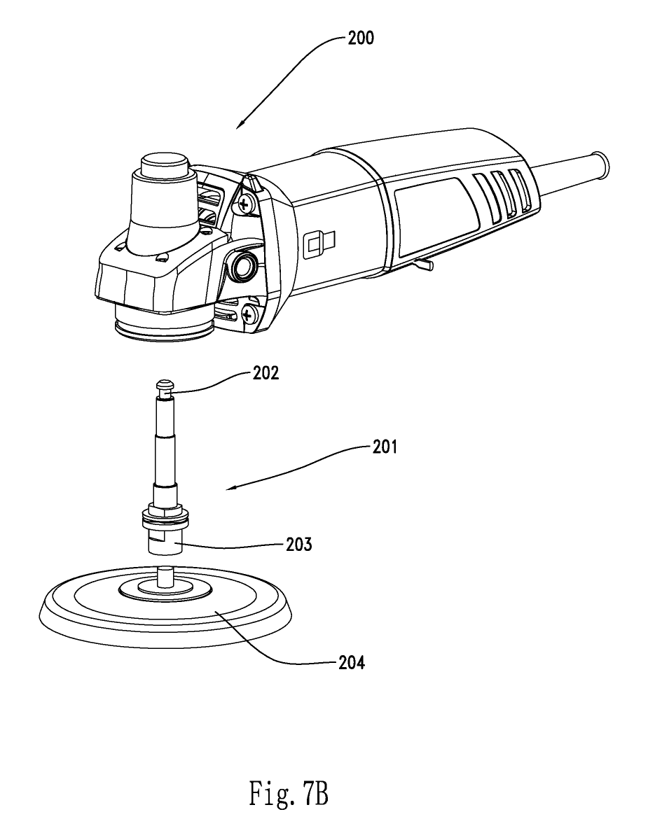

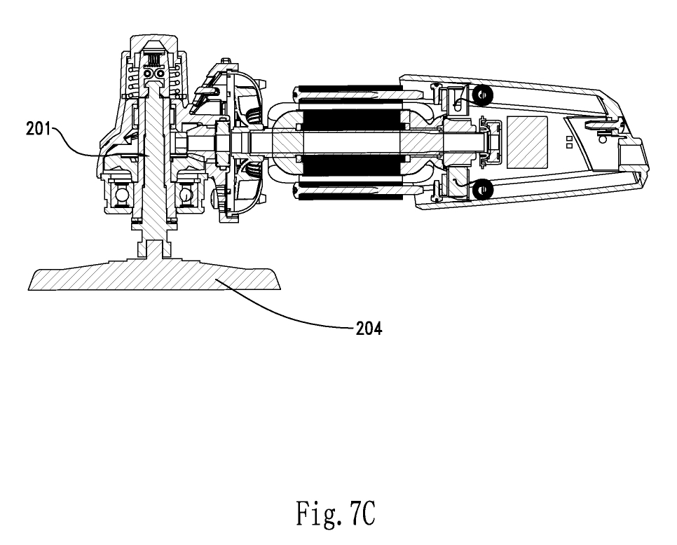

FIGS. 7A-7C illustrate a further embodiment, wherein the power tool 200 is a rotary sander. The upper connection structure 202 of the inner shaft 201 may not be changed, but the lower connection structure 203 is coaxially equipped with a chassis 204, so as to achieve the function of the rotary sander.

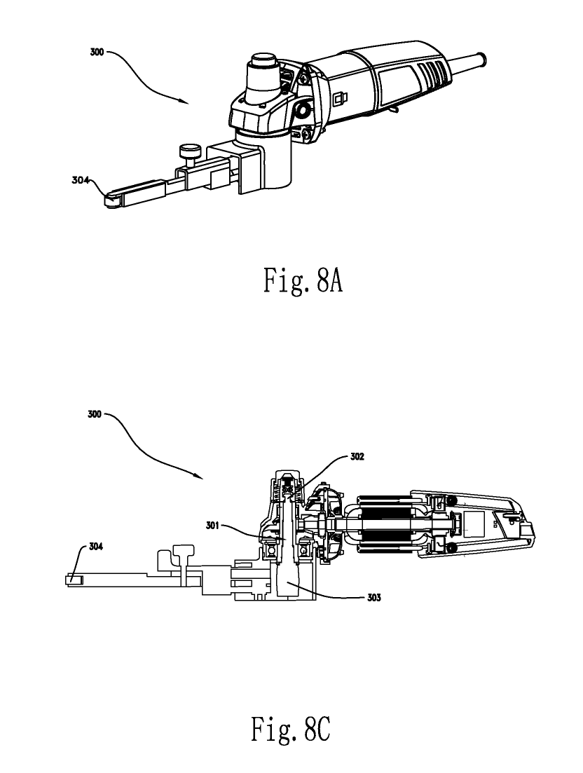

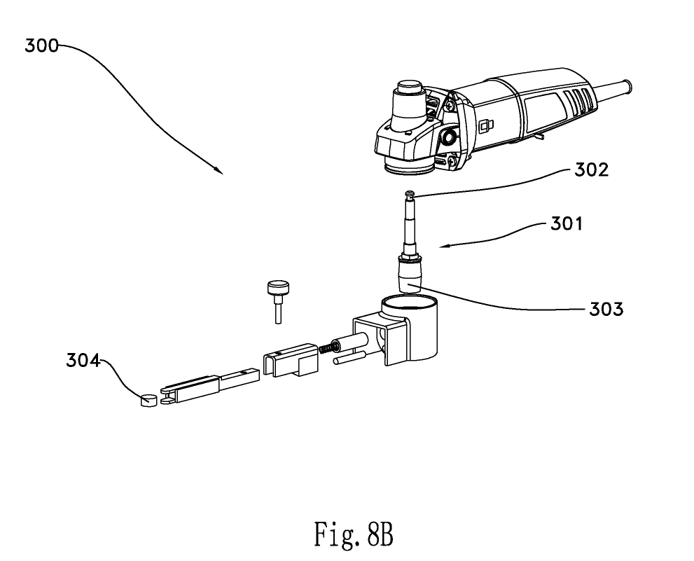

FIGS. 8A-8C illustrate a still further embodiment, wherein the power tool 300 is an electric rasper. The upper connection structure 302 of the inner shaft 301 may not be changed, but the lower connection structure 303 is equipped with a rasping head 304 via a connection mechanism, so as to achieve the function of the electric rasper.

In summary, the inner shafts in above embodiments have the same upper connection structures which enable the inner shaft in each embodiment to be releasably retained in the connecting spindle by the retaining assembly 33, and different lower connection structures which enable the inner shaft in each embodiment to be equipped with different working heads so as to obtain a power tool with various functions. Certainly, those skilled in the art will understand that different adapters can be arranged between the lower connection structure of the inner shaft and the working head, so that one inner shaft can be connected with many various working heads to obtain a power tool with various functions.

The disclosed specific embodiments are not intended to be limiting. Rather, those skilled in the art will appreciate that other alternative or modified embodiments can be adopted and these alternative or modified embodiments will be regarded as falling within the scope of the invention as defined by the following claims.

What is claimed is:

1. A power tool comprising:
a body portion having an associated head portion;
a motor located in the body portion;
a connecting spindle arranged within the head portion being driven by the motor for rotation; and
a first replaceable spindle which is releasably connectable to the connecting spindle, the first replaceable spindle having a first output portion adapted for mounting a working head.

2. The power tool as recited in claim 1, wherein the power tool further comprises a retaining assembly used for releasably connecting the first replaceable spindle to the connecting spindle.

3. The power tool as recited in claim 2, wherein the first replaceable spindle further comprises an upper portion which is releasably connectable to the retaining assembly.

4. The power tool as recited in claim 3, wherein the power tool further comprises a second replaceable spindle which is releasably connectable to the connecting spindle, the second replaceable spindle having an upper portion, which is the same as the upper portion of the first replaceable spindle, and a second output portion wherein two different working heads are mounted on the first output portion and the second output portion, respectively.

5. The power tool as recited in claim 4, wherein the second output portion of the second replaceable spindle is different from the first output portion of the first replaceable spindle.

6. The power tool as recited in claim 2, wherein the power tool further comprises an adapter and wherein the working head is connected to the first replaceable spindle via the adapter.

7. The power tool as recited in claim 2, wherein the retaining assembly is moveable between a first position and a second position and wherein, in the first position, the retaining assembly is connected to the first replaceable spindle and, in the second position, the retaining assembly is disconnected from the first replaceable spindle.

8. A power tool comprising:
a body portion having an associated head portion;
a motor located in the body portion having a motor output shaft with a first axis;
a transmission mechanism arranged in the head portion and connected with the motor output shaft, wherein the output of the transmission mechanism comprises a connecting spindle with a second axis; and
a first replaceable spindle which is releasably connectable to the connecting spindle, the first spindle having a first output portion adapted for mounting a working head.

9. The power tool as recited in claim 8, wherein the power tool further comprises a retaining assembly used for releasably connecting the first replaceable spindle to the connecting spindle.

10. The power tool as recited in claim 9, wherein the retaining assembly is moveable between a first position and a second position and wherein, in the first position, the retaining assembly is connected to the first replaceable spindle and, in said second position, said retaining assembly is disconnected from the first replaceable spindle.

11. The power tool as recited in claim 10, wherein the retaining assembly comprises a retaining element for releasably connecting the first replaceable spindle and an actuator which is used for releasing the first replaceable spindle from the connecting spindle manually by users.

12. The power tool as recited in claim 11, wherein the retaining assembly further comprises an elastic element which is mounted between the retaining element and the actuator.

13. The power tool as recited in claim 8, wherein the second axis of the connecting spindle is substantially perpendicular to the first axis of the motor output shaft.

14. The power tool as recited in claim 13, wherein the power tool further comprises a second replaceable spindle which is releasably connectable to the connecting spindle, the second replaceable spindle having a second output portion, and wherein two different working heads are mounted on the first output portion and the second output portion, respectively.

15. The power tool as recited in claim 14, wherein the second output portion of the second replaceable spindle is different from the first output portion of the first replaceable spindle.

16. The power tool as recited in claim 8, wherein the power tool further comprises an adapter and wherein the working head is connected to the first replaceable spindle via the adapter.

17. A power tool comprising:
a body portion having an associated head portion;
a motor located in the body portion having a motor output shaft with a first axis;
a transmission mechanism arranged in the head portion and connected with the motor output shaft, wherein the output of the transmission mechanism comprises a connecting spindle; and
a first spindle and a second spindle, each of the first spindle and the second spindle being selectively and releasably connectable to the connecting spindle, the first spindle having an output portion adapted for mounting a first working head and the second spindle having an output portion adapted for mounting a second working head wherein the first working head is different from the second working head.

18. The power tool as recited in claim 17, wherein the power tool further comprises a retaining assembly used for fixing one of the first spindle or the second spindle to the connecting spindle.

19. The power tool as recited in claim 18, wherein the retaining assembly is moveable between a first position and a second position and wherein, in the first position, the retaining assembly is connected to one of the first spindle or the second spindle and, in the second position, the retaining assembly is disconnected from the one of the first spindle or the second spindle.

20. A power tool comprising:
a body portion having an associated head portion;
a motor located in the body portion;
a connecting spindle arranged within the head portion and driven by the motor for rotation; and
a replaceable spindle which is releasably connectable to the connecting spindle, wherein the replaceable spindle is operable to mount different working heads via different adapters.
